(19) United States
(12) Patent Application Publication
(10) Pub. No.: US 2023/0081025 A1
(43) Pub. Date: Mar. 16, 2023

(54) Smart Lamp

(71) Applicant: Phillip Owens, Lakewood, CO (US)

(72) Inventor: Phillip Owens, Lakewood, CO (US)

(21) Appl. No.: 17/474,632

(22) Filed: Sep. 14, 2021

(51) Int. Cl. F21S 6/00; F21V 33/00; H05B 47/19; G06F 13/42

(52) U.S. Cl. CPC F21S 6/004; F21V 33/0056; H05B 47/19; G06F 13/4282; G06F 2213/0042

(57) ABSTRACT

The smart lamp combines an energy-efficient LED light with a flexible mounting arm for smartphones or tablets, a Bluetooth speaker, and a smartphone or tablet charger. The smart lamp uses less desk space by bundling three electronic devices into one convenient lamp. The user positions their cellular devices onto the mount at the end of the adjustable arm, thus keeping the phone within reach. Moreover, this modern device enables users to set ideal lighting, based on preference, while the universal phone charging ports allow for simultaneously charging up to (2) two phones. The disclosed invention ensures a fully operational, multi-purpose lamp that bundles up various electronic devices into one highly-functional product as a means to use less desk space and ensure a more versatile home accessory.

### BACKGROUND

An electric light is a device that produces visible light from electric power. It is the most common form of artificial lighting and is essential to modern society, providing interior lighting for buildings and exterior light for evening and nighttime activities. In technical usage, a replaceable component that produces light from electricity is called a lamp. An LED lamp or LED light bulb is an electric light that produces light using light-emitting diodes (LEDs). LED lamps are significantly more energy-efficient than equivalent incandescent lamps and can be significantly more efficient than most fluorescent lamps. The most efficient commercially available LED lamps have efficiencies of 200 lumens per watt (Lm/W). Commercial LED lamps have a lifespan many times longer than incandescent lamps.

### SUMMARY OF THE INVENTION

The main purpose of this invention is to provide users with an all-in-one smart lamp with charging, Bluetooth, and phone mounting abilities. According to various studies, an overwhelming number of individuals sleep with or next to their smartphones. Sleeping with a cellular device at such near proximity, however, has proven to emit dangerous radiation, and, therefore, can be incredibly hazardous to human health. Furthermore, hovering a mobile phone over the face for a prolonged time while in bed can not only lead to arm exhaustion, but can also cause eye damage.

The smart lamp reduces the health implications of having a cell phone nearby while sleeping, and enables users to use less desk space by bundling three electronic devices into one convenient lamp. The smart lamp enhances the functionality of an average lamp by introducing an energy-efficient LED light fixture with a flexible arm, that also conveniently operates as a speaker, charger, and phone mount. The user simply positions their cellular devices onto the mount at the end of the adjustable arm, and can therefore guarantee the phone is within reach, but also at a safe distance from the face when scrolling and/or while sleeping. Moreover, this modern device enables users to set ideal lighting, based on preference, while the universal phone charging ports allow for simultaneously charging up to (2) two phones. The disclosed invention ensures a fully operational, multi-purpose lamp that bundles up various electronic devices into one highly-functional product as a means to use less desk space and ensure a more versatile home accessory.

### BRIEF DESCRIPTION OF THE DRAWINGS

FIG. 1 is a perspective view of the smart lamp and included mounting arm in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

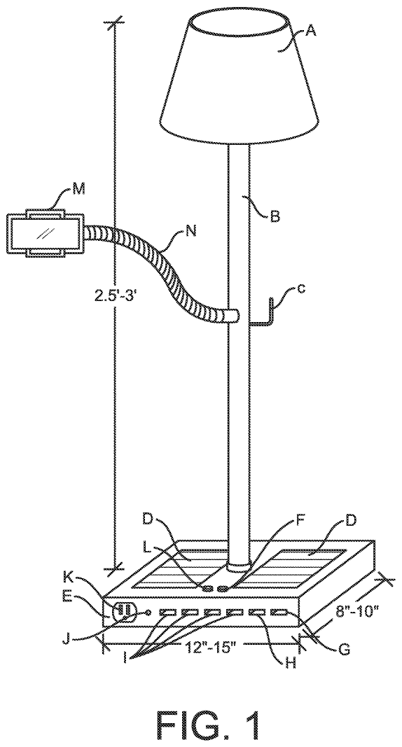

FIG. 1 is a perspective view of the smart lamp and included mounting arm in accordance with an embodiment of the present disclosure.

Reference A depicts the energy-efficient LED light at the top of the lamp. Reference B depicts the metal pole which connects the base of the lamp to the mounting arm and LED light. Reference C depicts a hook for headphones.

Reference D depicts a Bluetooth speaker, integrated into the base of the lamp. Reference E depicts the front of the wooden base of the lamp. Reference F depicts the power button and dimmer control for the LED light at the top of the lamp. Reference G depicts the charging port for Android phones, which do not use the Apple Lightning connector. Reference H depicts the charging port for Apple phones. Reference J depicts the AUX connector in the base, which connects to the speaker system. Reference K depicts the power outlet to power the smart lamp. Reference L shows the volume control for the speaker system.

Reference M shows the mount and clamp mechanism to hold a smartphone or tablet. Reference N shows the flexible arm, which is connected to the metal rod.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A smart lamp comprising:
a lamp base;
a lamp pole attached to the lamp base;
a lamp attached to the lamp pole; and
an adjustable arm attached to a lateral side of the lamp pole via a first end and configured to secure a cell phone via a mount clamp on a second end thereof.

2. The smart lamp of claim 1, wherein the adjustable arm comprises wires for power and communications between the cell phone and the lamp base.

3. The smart lamp of claim 1, further comprising a hook on the lamp pole configured to hold a pair of headphones.

4. The smart lamp of claim 1, further comprising a speaker in the lamp base in communication with the cell phone.

5. The smart lamp of claim 1, further comprising a plurality of universal serial bus ports in the lamp base.

6. The smart lamp of claim 1, further comprising an auxillary port in the lamp base.

7. The smart lamp of claim 1, further comprising an alternating current 120 volt power outlet in the lamp base.

8. The smart lamp of claim 1, further comprising a mount clamp to secure an electronic tablet.

9. The smart lamp of claim 1, further comprising a power dimmer in the lamp base for a light in the lamp.

10. The smart lamp of claim 1, further comprising a power supply connection for a home AC power to enter the smart lamp.

11. The smart lamp of claim 1, further comprising a volume control rotary switch for a pair of speakers in the smart lamp.

12. The smart lamp of claim 1, further comprising a port for interoperability and intercommunications between the cell phone and other cell phone attached thereto.

13. The smart lamp of claim 1, further comprising a wireless interoperability and intercommunications between the cell phone and another cell phone in a wireless vicinity thereto.

14. The smart lamp of claim 1, further comprising a controller in a communications between the cell phone and a control of the smart lamp.

15. The smart lamp of claim 1, further comprising a cell phone charging port in the lamp base.

16. The smart lamp of claim 1, wherein a weight of the lamp base is a multiple times heavier than a weight of the cell phone as a counter balance.

17. The smart lamp of claim 1, further comprising a fail safe switch configured to turn off the lamp based on a tipping sensor in the lamp base.

18. The smart lamp of claim 1, wherein a center of gravity of the adjustable arm fully extended and the lamp pole and lamp fall within an outside perimeter of the lamp base.

19. The smart lamp of claim 1, wherein a light source for the lamp is a light emitting diode LED.

20. The smart lamp of claim 1, wherein a communications between the cell phone and the lamp base is a hybrid wired and wireless communications.
